(19) United States
(12) Patent Application Publication
(10) Pub. No.: US 2025/0072389 A1
(43) Pub. Date: Mar. 6, 2025

(54) MULTIFUNCTIONAL CATTERY CAPABLE OF BEING QUICKLY DISASSEMBLED AND REASSEMBLED

(71) Applicant: Jun TIAN, Shanghai (CN)

(72) Inventor: Jun TIAN, Shanghai (CN)

(21) Appl. No.: 18/258,837

(22) PCT Filed: Oct. 21, 2022
(86) PCT No.: PCT/CN2022/126743

§ 371 Date: Jun. 22, 2023

(30) Foreign Application Priority Data
Mar. 3, 2022 (CN) 202210210388.2

(51) Int. Cl. A01K 1/03; A01K 1/00; F16B 5/07

(52) U.S. Cl. CPC A01K 1/033; A01K 1/0076; F16B 5/07

(57) ABSTRACT

The present disclosure provides a multifunctional cattery capable of being quickly disassembled and reassembled, and relates to the technical field of catteries. The multifunctional cattery includes a bottom bearing plate, two limiting side plates, a rear backboard, and a top protection plate; the bottom bearing plate, the top protection plate, and the two limiting side plates form an annular structure; the rear backboard is arranged in one opening of the annular structure; plugging blocks are arranged on an upper side, a lower side, and a rear side of any one of the above limiting side plates; plugging slots are formed in the bottom bearing plate, the top protection plate, and the rear backboard; and the plugging slots and the plugging blocks are in plugging fit. The multifunctional cattery can achieve free assembling or disassembling and can be recycled, which saves resources.

### TECHNICAL FIELD

The present disclosure relates to the technical field of catteries, particularly to a multifunctional cattery capable of being quickly disassembled and reassembled.

### BACKGROUND

In the past, people kept animals only for the purpose of eliminating loneliness or achieving entertainment. Nowadays, pets are defined as animals and plants kept for non-economic purposes. Pets are animals and plants kept for spiritual purposes, and are usually kept for the purpose of eliminating loneliness or achieving entertainment. Pets kept in the past were usually mammals or birds because these animals had well-developed brains and easily communicated with human. Nowadays, in addition to well-known live pets, there are also many virtual pets.

Cats belong to the feline family, are divided into domestic cats and wild cats, and widely serve as pets in households around the world. A cattery is a necessary entertainment and habitation place for pet cats, as well as a household necessity for keeping pet cats.

Catteries currently used are all of an integrated structure, meaning that boards that form the cattery cannot be disassembled and can only be used once, which greatly causes a waste of resources.

In conclusion, a multifunctional cattery capable of being quickly disassembled and reassembled is provided to solve the aforementioned technical problems.

### SUMMARY

The present disclosure aims to provide a multifunctional cattery capable of being quickly disassembled and reassembled, which can achieve free assembling or disassembling of the cattery and can be recycled, saving resources.

The embodiments of the present disclosure are achieved below:

The embodiments of the present disclosure provide a multifunctional cattery capable of being quickly disassembled and reassembled, including a bottom bearing plate, two limiting side plates, a rear backboard, and a top protection plate;
the two limiting side plates are arranged on an upper side of the bottom bearing plate; the two limiting side plates are distributed at two ends of the bottom bearing plate; the top protection plate is arranged above the bottom bearing plate; the top protection plate is connected to the two limiting side plates;
the bottom bearing plate, the top protection plate, and the two limiting side plates form an annular structure; the rear backboard is arranged in one opening of the annular structure;
plugging blocks are arranged on an upper side, a lower side, and a rear side of any one of the above limiting side plates; plugging slots are formed in the bottom bearing plate, the top protection plate, and the rear backboard; and the plugging slots and the plugging blocks are in plugging fit.

In some embodiments of the present disclosure, the multifunctional cattery capable of being quickly disassembled and reassembled further includes hooks&loops; the limiting side plates are simultaneously connected to opposite sides of the bottom bearing plate, the top protection plate, and the rear backboard through the hooks&loops.

In some embodiments of the present disclosure, a top side of the top protection plate is detachably provided with a connecting plate; and a fence is arranged on an upper side of the connecting plate.

In some embodiments of the present disclosure, first pillars are symmetrically arranged on a bottom side of the bottom bearing plate; arc-shaped plates are arranged on lower sides of the two first pillars; and the two arc-shaped plates are parallel to each other.

In some embodiments of the present disclosure, the limiting side plates are provided with heating modules.

In some embodiments of the present disclosure, second pillars are symmetrically arranged on the bottom side of the bottom bearing plate; mounting plates are arranged on lower sides of the second pillars; and electric wheels are arranged on lower sides of the mounting plates.

Compared with the prior art, the embodiments of the present disclosure at least have the following advantages or beneficial effects:

A multifunctional cattery capable of being quickly disassembled and reassembled includes a bottom bearing plate, two limiting side plates, a rear backboard, and a top protection plate;
the two limiting side plates are arranged on an upper side of the bottom bearing plate; the two limiting side plates are distributed at two ends of the bottom bearing plate; the top protection plate is arranged above the bottom bearing plate; the top protection plate is connected to the two limiting side plates;
the bottom bearing plate, the top protection plate, and the two limiting side plates form an annular structure; the rear backboard is arranged in one opening of the annular structure; plugging blocks are arranged on an upper side, a lower side, and a rear side of any one of the above limiting side plates; plugging slots are formed in the bottom bearing plate, the top protection plate, and the rear backboard; and the plugging slots and the plugging blocks are in plugging fit.

According to the present disclosure, to assemble the cattery, the bottom bearing plate is first placed on a plane; the two limiting side plates are symmetrically mounted on the upper side of the bottom bearing plate, and the plugging blocks on the lower sides of the limiting side plates and the plugging slots of the bottom bearing plate are correspondingly in plugging fit; the top protection plate is located above the bottom bearing plate, and the plugging slots of the top protection plate are in plugging fit with the plugging blocks of the limiting side plates; the rear backboard is mounted on the rear side of the annular structure formed by the bottom bearing plate, the limiting side plates, and the top protection plate; and the plugging slots of the rear backboard are in plugging fit with the plugging blocks of the limiting side plates. According to the above assembling, the bottom bearing plate, the two limiting side plates, the top protection plate, and the rear backboard are assembled into an accommodating structure (the cattery) with openings, which facilitates living of a cat. In the present disclosure, due to the assembled design of the bottom bearing plate, the two limiting side plates, the top protection plate, and the rear backboard, the formed cattery can also be assembled for use after being disassembled. The design of the multifunctional cattery can achieve free assembling or disassembling and can be recycled, which saves resources.

### BRIEF DESCRIPTION OF THE DRAWINGS

In order to explain the technical solutions of the embodiments of the present disclosure more clearly, the following will briefly introduce the accompanying drawings used in the embodiments. It should be understood that the drawings in the following description only illustrate some embodiments of the present disclosure and thus shall not be deemed as limiting the scope. Those of ordinary skill in the art can obtain other related drawings based on these drawings without creative work.

FIG. 1 is a first schematic structural diagram of a multifunctional cattery capable of being quickly disassembled and reassembled according to a first embodiment of the present disclosure;

FIG. 2 is a second schematic structural diagram of a multifunctional cattery capable of being quickly disassembled and reassembled according to a first embodiment of the present disclosure; and

FIG. 3 is a third schematic structural diagram of a multifunctional cattery capable of being quickly disassembled and reassembled according to a first embodiment of the present disclosure.

In the drawings: 1: bottom bearing plate; 2: limiting side plate; 3: top protection plate; 4: rear backboard; 5: arc-shaped plate; 6: fence; 7: connecting plate; 8: first pillar; and 9: mounting plate.

### DETAILED DESCRIPTION OF THE EMBODIMENTS

In order to make the objectives, technical solutions and advantages of the embodiments of the present disclosure clearer, the technical solutions in the embodiments of the present disclosure will be described clearly and completely below in combination with the drawings in the embodiments of the present disclosure. Obviously, the embodiments described herein are part of the embodiments of the present disclosure, not all the embodiments. The components of the embodiments of the present disclosure generally described and shown in the drawings here can be arranged and designed in a variety of different configurations.

Therefore, the following detailed description for the embodiments of the present disclosure provided in the accompanying drawings is not intended to limit the scope of the claimed present disclosure, but merely represents selected embodiments of the present disclosure. Based on the embodiments in the present disclosure, all other embodiments obtained by those of ordinary skill in the art without doing creative work shall fall within the protection scope of the present disclosure.

It should be noted that similar reference signs and letters indicate similar items in the following drawings. Therefore, once a certain item is defined in one drawing, it is unnecessary to be further defined and explained in the subsequent drawings.

In the description of the embodiments of the present disclosure, it should be noted that orientations or positional relationships indicated by the terms “center”, “upper”, “lower”, “left”, “right”, “vertical”, “horizontal”, “inner” and “outer” are based on the orientations or positional relationships shown in the accompanying drawings, or the orientations or positional relationships where a product of the present disclosure is usually placed during use, which are only for the convenience of describing the present disclosure and simplifying the description, not intended to indicate or imply that the referred device or element must have a particular orientation and be constructed and operated in a particular orientation. Therefore, they should not be construed as a limitation to the present disclosure. In addition, the terms “first”, “second”, “third”, etc. are only for the purpose of distinguishing descriptions, and may not be understood as indicating or implying the relative importance.

In addition, the terms “horizontal”, “vertical”, “overhang” and the like do not mean that the component is required to be absolutely horizontal or overhanging, but may be slightly inclined. For example, “horizontal” only means that its direction is more horizontal than “vertical”, and it does not mean that the structure must be completely horizontal, but can be slightly inclined.

In the description of the embodiments of the present disclosure, “plurality” represents at least two.

In the description of the embodiments of the present disclosure, it should be also noted that unless otherwise explicitly defined and defined, the terms “arranged”, “mounted”, “coupled”, and “connected” shall be understood broadly, and may be, for example, fixedly connected, or removably connected, or integrally connected, or mechanically connected, or electrically connected, or directly connected, or indirectly connected through an intermediate medium, or internal connection between two elements. For those of ordinary skill in the art, the specific meanings of the above terms in the present disclosure can be understood according to specific situations.

### Embodiment 1

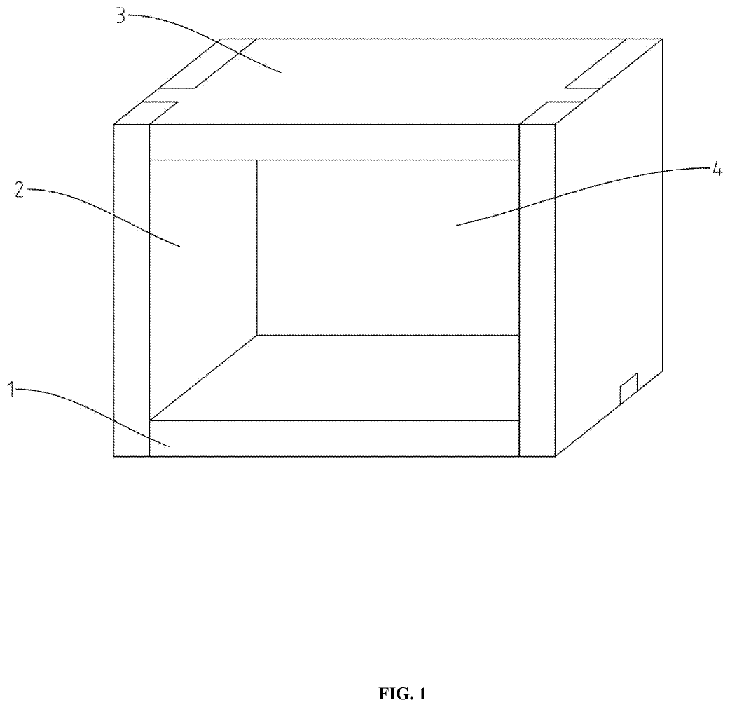

Referring to FIG. 1, this embodiment of the present disclosure provides a multifunctional cattery capable of being quickly disassembled and reassembled, including a bottom bearing plate 1, two limiting side plates 2, a rear backboard 4, and a top protection plate 3.

The two limiting side plates 2 are arranged on an upper side of the bottom bearing plate 1. The two limiting side plates 2 are distributed at two ends of the bottom bearing plate 1. The top protection plate 3 is arranged above the bottom bearing plate 1. The top protection plate 3 is connected to the two limiting side plates 2.

The bottom bearing plate 1, the top protection plate 3, and the two limiting side plates 2 form an annular structure. The rear backboard 4 is arranged in one opening of the annular structure.

Plugging blocks are arranged on an upper side, a lower side, and a rear side of any one of the above limiting side plates 2. Plugging slots are formed in the bottom bearing plate 1, the top protection plate 3, and the rear backboard 4. The plugging slots and the plugging blocks are in plugging fit.

According to the present disclosure, to assemble the cattery, the bottom bearing plate 1 is first placed on a plane; the two limiting side plates 2 are symmetrically mounted on the upper side of the bottom bearing plate 1, and the plugging blocks on the lower sides of the limiting side plates 2 and the plugging slots of the bottom bearing plate 1 are correspondingly in plugging fit; the top protection plate 3 is located above the bottom bearing plate 1, and the plugging slots of the top protection plate 3 are in plugging fit with the plugging blocks of the limiting side plates 2; the rear backboard 4 is mounted on the rear side of the annular structure formed by the bottom bearing plate 1, the limiting side plates 2, and the top protection plate 3; and the plugging slots of the rear backboard 4 are in plugging fit with the plugging blocks of the limiting side plates 2. According to the above assembling, the bottom bearing plate 1, the two limiting side plates 2, the top protection plate 3, and the rear backboard 4 are assembled into an accommodating structure (the cattery) with openings, which facilitates living of a cat. In the present disclosure, due to the assembled design of the bottom bearing plate 1, the two limiting side plates 2, the top protection plate 3, and the rear backboard 4, the formed cattery can also be assembled for use after being disassembled. The design of the multifunctional cattery can achieve free assembling or disassembling and can be recycled, which saves resources.

During actual assembling, different boards can be selected to form different types of catteries, which have flexible implementations and enrich the diversity and enjoyment of the present disclosure. Moreover, the same cattery can be spliced and extended in multiple directions.

Optionally, the cattery can be made of biodegradable pearl cotton, matched with various fresh colors such as pink, blue, and cyan, creating a romantic atmosphere. The soft fabric can be bent freely without deformation. The unique summer style is made of PU leather, which is durable. In addition to providing a comfortable resting area for cats, the cattery is also provided with playing facilities for cats, such as a scratcher and a cat tree: The stable scratcher is resistant to scratching and biting. The top of the scratcher adopts a circular ball to attract the attention of cats. The top of the cattery is provided with the cat tree, which facilitates cats to jump up and down more happily. A manufacturing material of the cat tree is safe, which ensures that the cats play more safely.

In some embodiments of the present disclosure, the multifunctional cattery capable of being quickly disassembled and reassembled further includes hooks&loops; the limiting side plates 2 are simultaneously connected to opposite sides of the bottom bearing plate 1, the top protection plate 3, and the rear backboard 4 through the hooks&loops.

In the above embodiment, Pinyin of HOOK&LOOP is mó shù tiē, also referred to as hook and loop tape or creaking fastener (which makes a creaking sound and acts as a button). It is a commonly used connecting accessory on clothes, and has a child side and a mother side. The hooks&loops connect the limiting side plates 2 to the opposite sides of the bottom bearing plate 1, the top protection plate 3, and the rear backboard 4, which further improves the stability of the overall structure of the present disclosure. It should be noted that the hook&loop is only one implementation of the embodiments of the present disclosure and does not limit a connecting structure. In other embodiments, other connecting structures are acceptable.

Optionally, a connecting way of the hook&loop can also be replaced by a magnetic attraction. The magnetic attraction makes the limiting side plates 2 simultaneously connected to the opposite sides of the bottom bearing plate 1, the top protection plate 3, and the rear backboard 4, and has the advantages of easy operation and fast connection.

### Embodiment 2

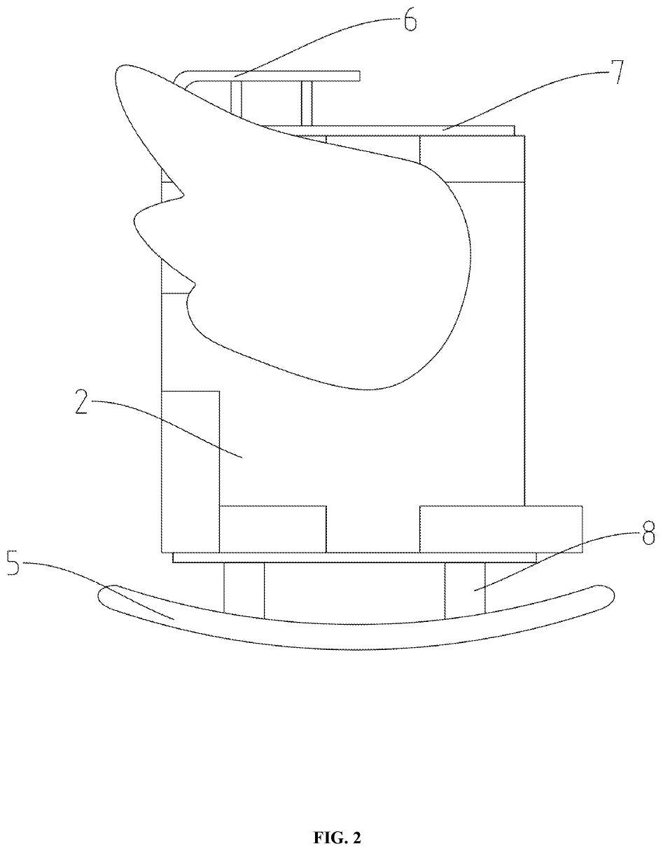

Referring to FIG. 2, the main body structure of the present disclosure is not changed. This embodiment is a further improvement based on Embodiment 1, which is specifically as follows:

In some embodiments of the present disclosure, a top side of the top protection plate 3 is detachably provided with a connecting plate 7; and a fence 6 is arranged on an upper side of the connecting plate 7.

In the above embodiment, the connecting plate 7 can be connected to the top protection plate 3 through the hook&loop which can achieve fast connection or removal of the connecting plate 7 from the top protection plate 3 to achieve free assembling of the structures of the present disclosure. The fence 6 is arranged along an edge of the upper side of the connecting plate 7, and a length of the fence 6 is less than a perimeter of the connecting plate 7. When a cat moves on the connecting plate 7, the fence 6 has a stop effect on the cat, which improves the safety of the cat during the movement.

### Embodiment 3

The main body structure of the present disclosure is not changed. This embodiment is a further improvement based on Embodiment 2, which is specifically as follows:

In some embodiments of the present disclosure, first pillars 8 are symmetrically arranged on a bottom side of the bottom bearing plate 1; arc-shaped plates 5 are arranged on lower sides of the two first pillars 8; and the two arc-shaped plates 5 are parallel to each other.

In the above embodiment, there are four first pillars 8. The four first pillars 8 are rectangularly distributed. One pair of adjacent first pillars 8 is connected to one arc-shaped plate 5, and the other pair of adjacent first pillars 8 are connected to the other arc-shaped plate 5. Arc-shaped portions of the arc-shaped plates 5 are in contact with a placement surface of the present disclosure. When a cat enters the cattery, the cat can sway from side to side to form a cradle structure, which improves the enjoyment of the present disclosure.

Optionally, the four first pillars 8 are all detachably connected to the bottom side of the bottom bearing plate 1, so that a whole composed of the arc-shaped plates 5 and the first pillars 8 are detachable, thereby achieving free assembling and making the arc-shaped plates 5 used more flexibly. The first pillars 8 are cylindrical. The first pillars 8 are provided with external threads. Internal threads which are in threaded fit with the external threads of the first pillars 8 are arranged on the bottom side of the bottom bearing plate 1. Due to the threaded fitness, the first pillars 8 can be quickly removed or mounted.

### Embodiment 4

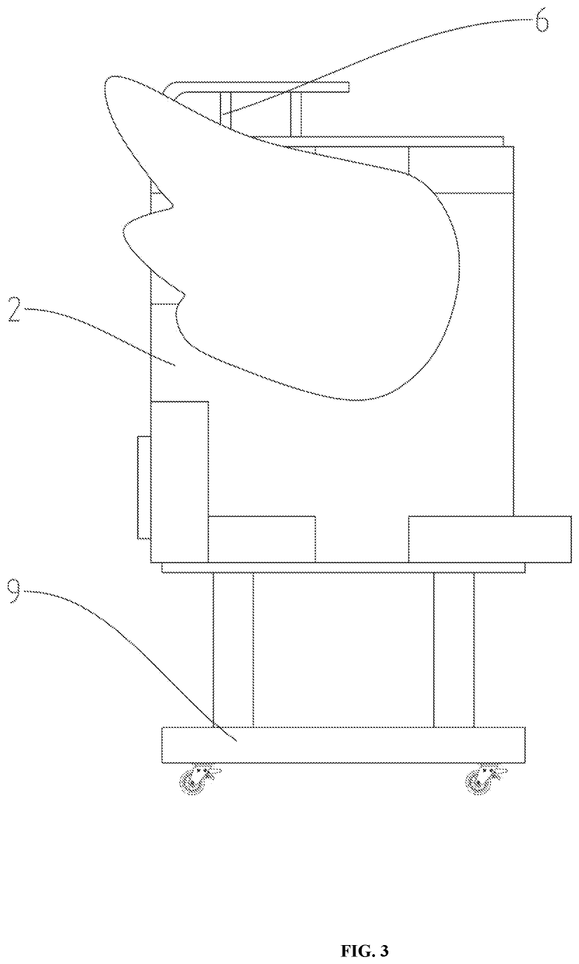

Referring to FIG. 3, the main body structure of the present disclosure is not changed. This embodiment is a further improvement based on Embodiment 1, which is specifically as follows:

In some embodiments of the present disclosure, the limiting side plates 2 are provided with heating modules.

In the above embodiment, the heating modules are configured to heat the cattery, thereby adjusting a temperature in the cattery.

Optionally, each heating module is a ferrochromic aluminum electrothermal alloy heating wire. Ferrochromic aluminum electrothermal alloy has a high operating temperature, with a maximum operating temperature up to 1400 DEG C., long service life, high surface load, good oxidation resistance, high resistivity, low price, and the like. The present disclosure has a beautiful appearance and beautiful color, and has functions of cattery heating, online teasing of a cat, a multilayer three-dimensional cat tree, and a desk lamp. It is a great boon for cat families to create a high-quality life. The fabric is soft and has an excellent handfeeling, making a cat comfortable and naturally enjoy the cattery. Sofas and other furniture of an owner can be spared.

In some embodiments of the present disclosure, second pillars are symmetrically arranged on the bottom side of the bottom bearing plate 1; mounting plates are arranged on lower sides of the second pillars; and electric wheels are arranged on lower sides of the mounting plates.

In the above embodiments, the first pillars are cylindrical. The first pillars are provided with external threads. Internal threads which are in threaded fit with the external threads of the second pillars are arranged on the bottom side of the bottom bearing plate. Due to the threaded fitness, the second pillars can be quickly removed or mounted. A mobile phone terminal controls the electric wheels to move, so as to adjust the position of the cattery. When the cattery is moved to an indoor illuminated place, the cat can bask in the sun, so that cat hairs left on the ground or the sofa because the cat lies on the ground or the sofa can be avoided.

In summary, the embodiments of the present disclosure provide a multifunctional cattery capable of being quickly disassembled and reassembled, which has at least the following technical effects:

In the first aspect, the present disclosure is different from existing market cattery products that use a fixed structure with screws. This kind of cattery can be completely mounted without professional tools, and can be assembled and spliced in various ways, such as embedding and magnetic attraction. Its modular structure can adapt to different needs of cats without changing the structure of the product. A user can add an electrothermal constant-temperature module to achieve a constant temperature of the cattery, which has good insulation performance and can make the cattery warm and comfortable, to meet the requirements of kittens for an environmental temperature. In addition, optical and electronic modules can also be added to create toys such as a cat teaser, to achieve an interaction functions, such as online cat teasing, which provides a user and a pet with a space for intimate contact and pleasant interaction. In the second aspect, the cattery adopts smooth rounded rectangular plates, without sharp hard objects, thereby preventing injury o the skin of a cat. The cattery adopts a semi-enclosed structure, inspired by a cardboard box shape that cats particularly love, so as to provide the cats with a safe and comfortable space to take a rest, as well as to provide the cats with a desired visual field, to give the cats a sense of trust and good privacy.

The above descriptions are merely preferred embodiments of the present disclosure and are not intended to limit the present disclosure. For those skilled in the art, the present disclosure may have various modifications and changes. Any modification, equivalent replacement, improvement, etc. made within the spirit and principle of the present disclosure shall all fall within the protection scope of the present disclosure.

What is claimed is:

1. A multifunctional cattery capable of being quickly disassembled and reassembled, comprising a bottom bearing plate, two limiting side plates, a rear backboard, and a top protection plate, wherein
the two limiting side plates are arranged on an upper side of the bottom bearing plate; the two limiting side plates are distributed at two ends of the bottom bearing plate; the top protection plate is arranged above the bottom bearing plate; the top protection plate is connected to the two limiting side plates;
the bottom bearing plate, the top protection plate, and the two limiting side plates form an annular structure; the rear backboard is arranged in one opening of the annular structure;
plugging blocks are arranged on an upper side, a lower side, and a rear side of any one of the above limiting side plates; plugging slots are formed in the bottom bearing plate, the top protection plate, and the rear backboard; and the plugging slots and the plugging blocks are in plugging fit.

2. The multifunctional cattery capable of being quickly disassembled and reassembled according to claim 1, further comprising hooks&loops, wherein the limiting side plates are simultaneously connected to opposite sides of the bottom bearing plate, the top protection plate, and the rear backboard through the hooks&loops.

3. The multifunctional cattery capable of being quickly disassembled and reassembled according to claim 2, wherein a top side of the top protection plate is detachably provided with a connecting plate; and a fence is arranged on an upper side of the connecting plate.

4. The multifunctional cattery capable of being quickly disassembled and reassembled according to claim 1, wherein first pillars are symmetrically arranged on a bottom side of the bottom bearing plate; arc-shaped plates are arranged on lower sides of the two first pillars; and the two arc-shaped plates are parallel to each other.

5. The multifunctional cattery capable of being quickly disassembled and reassembled according to claim 1, wherein the limiting side plates are provided with heating modules.

6. The multifunctional cattery capable of being quickly disassembled and reassembled according to claim 1, wherein second pillars are symmetrically arranged on the bottom side of the bottom bearing plate; mounting plates are arranged on lower sides of the second pillars; and electric wheels are arranged on lower sides of the mounting plates.
